(19) United States
(12) Patent Application Publication
(10) Pub. No.: US 2020/0115915 A1
(43) Pub. Date: Apr. 16, 2020

(54) CONNECTION SYSTEM AND BUILDING

(71) Applicant: HONDA MOTOR CO., LTD., MlNATO-KU, TOKYO (JP)

(72) Inventors: Takehisa TANAKA, WAKO-SHI, SAITAMA-KEN (JP); Kota ISHIKAWA, WAKO-SHI, SAITAMA-KEN (JP)

(21) Appl. No.: 16/626,789

(22) PCT Filed: Jun. 28, 2017
(86) PCT No.: PCT/JP2017/023711

§ 371 Date: Dec. 26, 2019

(51) Int. Cl. E04H 6/02; B60N 2/30

(52) U.S. Cl. CPC E04H 6/02; B60N 2/30

(57) ABSTRACT

Provided are: a connection system that can either improve convenience or achieve improved operability or cost reduction; and a building. A connection system has a mobile body and a building. The building has: a floor that connects with the floor surface of the mobile body; and a wall that integrates with a first opening-closing body of the mobile body in an opened state when the floor surface of the mobile body is connected to the floor.

### TECHNICAL FIELD

The present invention relates to a connection system for connecting a mobile entity to a building, and a building.

### BACKGROUND ART

Japanese Laid-Open Patent Publication No. 2001-271500 (hereinafter referred to as “JP 2001-271500 A”) is directed to providing a house that facilitates a person in a wheelchair getting on and off an automobile ([0004] and Abstract). To that end, JP 2001-271500 A (Abstract) includes forming a floor 4A of a house 1 as a flat floor without steps, which can be obstacles when a physically disabled person 5 or an elderly person moves around a room. An opening 7 is provided in an outer wall surface 6 of the house 1, and the floor 4A to be connected with the opening 7 is provided to the height level of a floor 22 of an automobile 20.

This eliminates a step at the boundary between the floor 4A in the house and the floor 22 of the automobile 20, allowing a flat floor without steps, or a so-called barrier-free floor, to be continuous to the automobile 20 from the house. Thus, a completely barrier-free floor is formed such that a person in a wheelchair 5A is able to get on and off the automobile 20 on his/her own without help from others and there is no interference with movement in the wheelchair 5A within the house 1. Thus, a person in the wheelchair 5A can easily get on and off the automobile 20.

Also in JP 2001-271500 A (FIGS. 3 and [0013]), a rear door 23 of the automobile 20 is fully turned via a hinge 23A when the person in the wheelchair 5A gets on or off the automobile 20. Then, by sliding a rotation shaft 23B along a rail member 25A from that state, the rear door 23 is positioned on the outer side of a side wall portion 25. This aims at preventing the rear door 23 from being an obstacle when the physically disabled person 5 in the wheelchair 5A gets on the automobile 20 from a living room 4 and vice versa.

### SUMMARY OF INVENTION

As mentioned above, in JP 2001-271500 A, the rear door 23 of the automobile 20 is positioned on the outer side of the side wall portion 25 when the person in the wheelchair 5A gets on or off the automobile 20 (FIG. 3 and [0013]). Such a configuration however complicates a structure for displacing the rear door 23, which can lead to reduced operability or increased cost. In addition, in a case where a sliding door is provided on a side of the automobile 20, the sliding door cannot be opened while the rear door 23 is positioned on the outer side of the side wall portion 25, leading to lower convenience.

Such challenges can also apply to a connection system that includes a vehicle or a mobile entity other than an automobile and a building or to the building included in such a connection system.

The present invention has been made in view of such challenges and an object thereof is to provide a connection system and a building that can improve operability, reduce costs, or improve convenience.

A connection system according to the present invention includes: a mobile entity; and a building having a floor which connects to a floor surface of the mobile entity and a wall which integrally fits with a first opening and closing element of the mobile entity in an open state while the floor surface of the mobile entity is connected with the floor.

In the present invention, the first opening and closing element of the mobile entity in an open state integrally fits with the wall while the floor surface of the mobile entity is connected with the floor of the building. This can simplify a displacement mechanism for the first opening and closing element compared to a case of positioning the rear door (the first opening and closing element) on a side of an automobile (mobile entity) as in JP 2001-271500 A, thus improving the operability or reducing cost. In a case where the mobile entity is a vehicle with a sliding door, getting on and off is also possible through the sliding door when getting on and off takes place between the vehicle and the building, which improves convenience.

The building may have, in the wall of the building, a housing portion for housing at least a portion of the first opening and closing element when the first opening and closing element is placed in an open state during connection with the mobile entity. This enables the first opening and closing element to be placed at a specific position when getting on and off takes place between the mobile entity and the building, which can improve the operability.

The first opening and closing element may be a gate provided in an opening at an end of the mobile entity. The gate may open and close in a horizontal direction. This enables getting on and off between the mobile entity and the building to be done by opening the gate in the horizontal direction even if the height of a ceiling of the building has significant limitations.

Alternatively, the gate may open and close in a vertical direction. This enables getting on and off between the mobile entity and the building to be done by opening the gate in the vertical direction even if the position of a side wall of the building has significant limitations.

The gate may have hooks or a lighting device on an interior-side surface of the gate. This allows the hooks or the lighting device to be used at least when the gate is opened.

The mobile entity may have seats on which occupants can sit. Seat backs of the seats may be capable of being housed under a floor so as to be flush with a floor surface of the mobile entity. This allows effective use of the floor surface of the mobile entity while the mobile entity is connected with the building.

The building may have, at a location adjacent to an entrance, a stopping space in which the mobile entity is stopped during connection. This can make the point of entry and exit to/from the building through the entrance and the point of entry and exit to/from the building through the mobile entity close to each other. Thus, the layout of the building can be simplified compared to when the two points are apart from each other.

When a second opening and closing element provided on a side of the mobile entity is placed in an open state by being moved from an initial position to another position with the mobile entity stopped in the stopping space, an opening formed in the initial position may communicate with the entrance. Thus, opening of the second opening and closing element permits an occupant getting off the mobile entity to immediately get to the entrance.

The building may have a wall surface or a lattice which is situated between the entrance and the second opening and closing element when the second opening and closing element is placed in an open state with the mobile entity stopped in the stopping space. This allows the second opening and closing element in an open state to be housed between the wall surface or lattice and the mobile entity.

The mobile entity may perform connection in an automated driving mode in which the mobile entity recognizes a surrounding environment and moves autonomously regardless of a driving mode before the connection. This permits easy connection of the mobile entity to the building.

Recognition of the surrounding environment may include communication performed between the mobile entity and the building. This can improve the accuracy of positioning of the mobile entity relative to the building.

A building according to the present invention includes: a floor which connects to a floor surface of a mobile entity; and a wall which integrally fits with a first opening and closing element of the mobile entity in an open state while the floor surface of the mobile entity is connected with the floor.

The present invention can improve operability, reduce costs, or improve convenience.

### BRIEF DESCRIPTION OF DRAWINGS

FIG. 1 schematically shows a configuration of a connection system according to a first embodiment of the present invention;

FIG. 2 is a perspective view showing a first situation during connection of a vehicle to a house in the first embodiment;

FIG. 3A is a plan view showing a second situation during connection of the vehicle to the house in the first embodiment and FIG. 3B is a side view corresponding to FIG. 3A;

FIG. 4A is a plan view showing a third situation during connection of the vehicle to the house in the first embodiment and FIG. 4B is a side view corresponding to FIG. 4A;

FIG. 5A is a plan view showing a fourth situation during connection of the vehicle to the house in the first embodiment and FIG. 5B is a side view corresponding to FIG. 5A;

FIG. 6 is a flowchart of automated connection control in the first embodiment;

FIG. 7 is a flowchart of connection assist control in the first embodiment;

FIG. 8 is a side view showing a situation of connection between the house and the vehicle included in the connection system according to a second embodiment; and

FIG. 9 is a side view showing a situation of connection between the house and the vehicle included in the connection system according to a third embodiment.

### DESCRIPTION OF EMBODIMENTS

### A. First Embodiment

### A-1. Configuration

### [A-1-1. Overview]

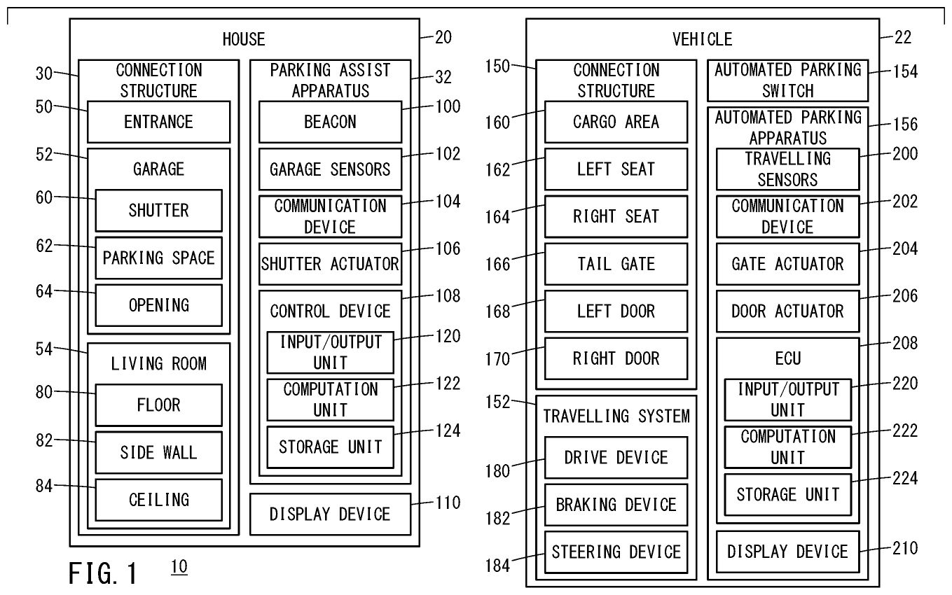

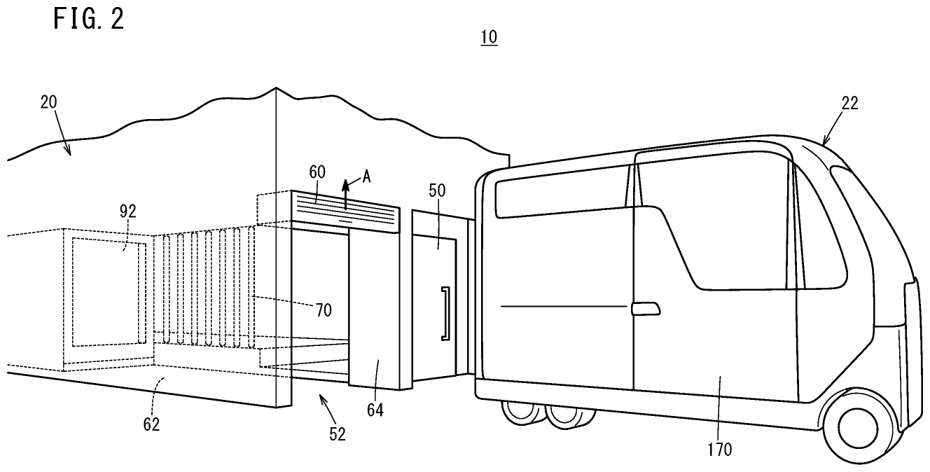

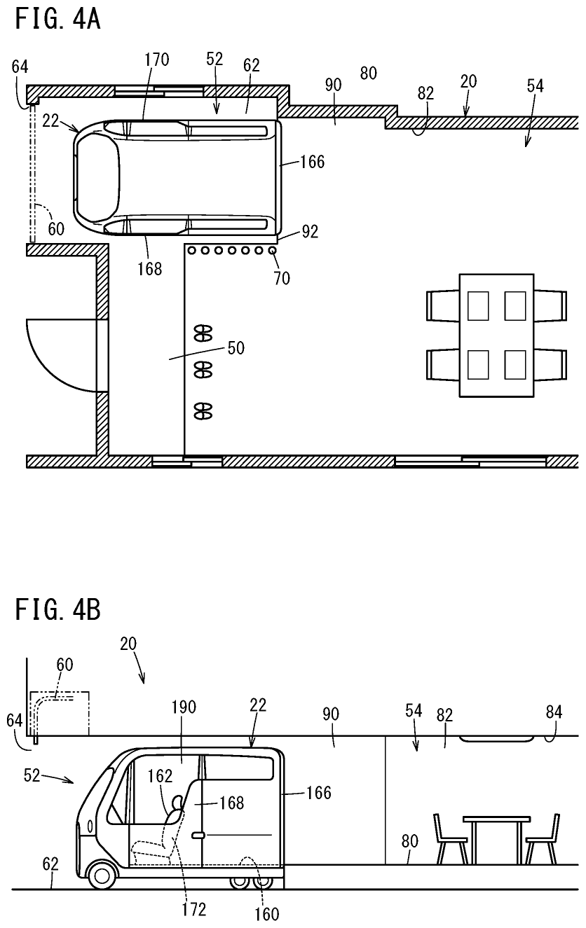

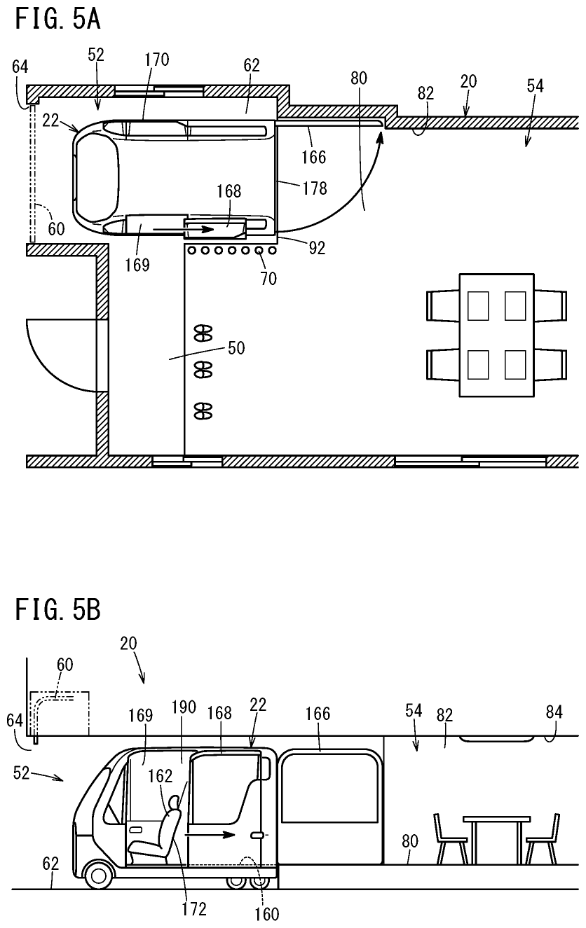

FIG. 1 schematically shows a configuration of a connection system 10 according to a first embodiment of the present invention. The connection system 10 includes a house 20 and a vehicle 22. The vehicle 22 is capable of connecting to the house 20 (described in more detail below with reference to FIGS. 2 to 7). A tail gate 166 of the vehicle 22 is used as part of a side wall 82 of the house 20 (described in more detail below with reference to FIGS. 5A and 5B).

### [A-1-2. House 20]

### (A-1-2-1. Overview of House 20)

As shown in FIG. 1, the house 20 includes a house-side connection structure 30 (hereinafter also called “connection structure 30”), and a parking assist apparatus 32. The connection structure 30 is a section for the vehicle 22 to connect, including an entrance 50, a garage 52, a living room 54, and a kitchen and the like not shown. The parking assist apparatus 32 assists the vehicle 22 to park at a target parking position Ptar in the garage 52.

### (A-1-2-2. House-Side Connection Structure 30)

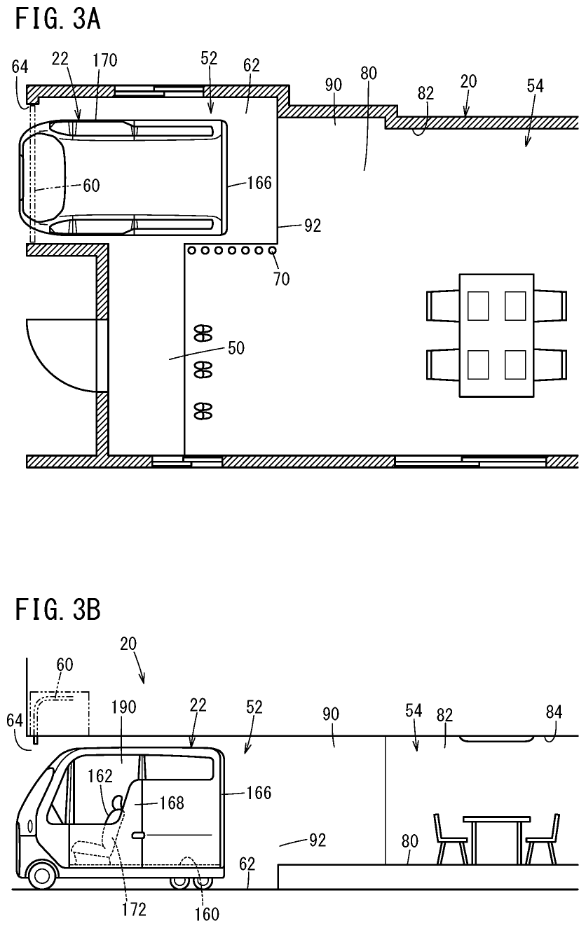

The entrance 50 is a section through which residents enter and exit the house 20. The garage 52 is a section where the vehicle 22 parks, including a shutter 60 and a parking space 62 (an earth floor). The shutter 60 opens and closes an opening 64 which allows the vehicle 22 to enter and exit the garage 52. The parking space 62 is a space for parking the vehicle 22, being an earth floor in the first embodiment. In the first embodiment, the garage 52 adjoins the entrance 50 (see FIG. 3A, for instance).

A lattice 70 (FIG. 2) is positioned between the entrance 50 and the garage 52. The lattice 70 is situated between the entrance 50 and the vehicle 22 when the vehicle 22 is in the parking space 62.

The living room 54 is a place where the residents live and is linked with the entrance 50 and the garage 52 in the first embodiment (see FIG. 3A, for instance). The living room 54 has a floor 80, a side wall 82, a ceiling 84, and the like. The floor 80 of the living room 54 is configured to connect with the interior of the vehicle 22 (a cargo area 160, discussed below). In other words, the height of the floor 80 is substantially equal to the height of the cargo area 160.

The side wall 82 accommodates the tail gate 166 (a first opening and closing element) in an open state such that the tail gate 166 becomes a part of the side wall 82 while the interior of the vehicle 22 is connected with the floor 80. More specifically, the side wall 82 has a housing portion 90 (FIG. 3A, for instance) as a recess formed therein so that the tail gate 166 in an open state is housed within the housing portion 90. As the tail gate 166 is opened, the tail gate 166 passes through an opening 92 (FIG. 3A, for instance) formed between the parking space 62 and the floor 80.

### (A-1-2-3. Parking Assist Apparatus 32)

The parking assist apparatus 32 assists the vehicle 22 to park in the garage 52. As shown in FIG. 1, the parking assist apparatus 32 includes a beacon 100, garage sensors 102, a communication device 104, a shutter actuator 106, a control device 108, and a display device 110.

The beacon 100 notifies the vehicle 22 of the target parking position Ptar (position coordinates) of the vehicle 22. The garage sensors 102 detect a current position Pc of the vehicle 22 in the garage 52, including, for example, a first image sensor which captures images outside the shutter 60, a second image sensor which captures images inside the shutter 60, and a third image sensor positioned near the target parking position Ptar.

The communication device 104 performs wireless communication with the vehicle 22. The shutter actuator 106 automatically opens and closes the shutter 60 and includes an electric motor, for example.

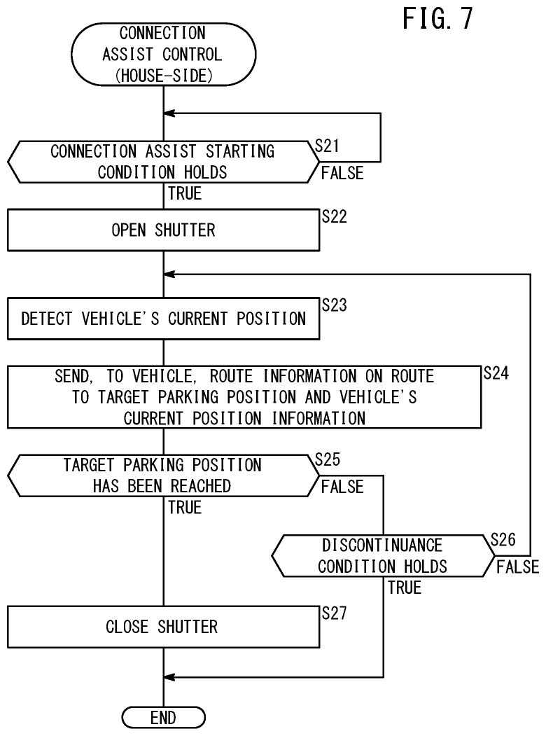

The control device 108 executes connection assist control (or parking assist control), which assists the vehicle 22 to reach the target parking position Ptar and connect to the house 20 (described in more detail below with reference to FIG. 7). The control device 108 includes an input/output unit 120, a computation unit 122, and a storage unit 124 as hardware components. The input/output unit 120 performs input and output between the control device 108 and other devices (for example, the beacon 100).

The computation unit 122 includes a central processing unit (CPU) and outputs parking assist information to the vehicle 22 using programs and data stored in the storage unit 124. The parking assist information is sent to the vehicle 22 through the beacon 100 or the communication device 104.

The storage unit 124 stores programs and data for use by the computation unit 122 and includes random access memory (hereinafter called “RAM”). For the RAM, volatile memory such as a register and non-volatile memory such as flash memory can be used. The storage unit 124 may also have read-only memory (hereinafter called “ROM”) in addition to the RAM.

The display device 110 installed with the control device 108 displays the status of the control device 108 and the like. The control device 108 and the display device 110 are positioned near the parking space 62, for example (they are not depicted in FIGS. 2 to 5B).

### [A-1-3. Vehicle 22]

### (A-1-3-1. Overview of Vehicle 22)

The vehicle 22 is capable of connecting to the house-side connection structure 30 of the house 20. The vehicle 22 in the first embodiment is an electric automobile (a battery-powered automobile) in a narrow definition, which travels only with energy from a battery, not shown. As shown in FIG. 1, the vehicle 22 includes a vehicle-side connection structure 150 (hereinafter also called “connection structure 150”), a traveling system 152, an automated parking switch 154, and an automated parking apparatus 156. The connection structure 150 is a section for the vehicle 22 to connect to the house-side connection structure 30, and includes the cargo area 160, a left seat 162, a right seat 164, a tail gate 166, a left door 168, and a right door 170.

In the first embodiment, the vehicle 22 has two seats (2-seater type); however, it may have a different number of seats (for example, 4 or 6). The automated parking apparatus 156 allows the vehicle 22 to be automatically parked at the target parking position Ptar in the garage 52.

### (A-1-3-2. Vehicle-Side Connection Structure 150)

As noted above, the cargo area 160 is positioned at a substantially equal height to the floor 80 of the house 20. One way of equalizing the heights is to make the cargo area 160 with the same height as the floor 80. It is also possible to place a height increasing member such as a plate on the cargo area 160 in order to increase the height of the cargo area 160. On the left seat 162 and the right seat 164, occupants not shown can sit.

Seat backs 172 (FIG. 3B, for instance) of the left seat 162 and the right seat 164 may be capable of being housed under the floor so as to be flush with the floor surface of the vehicle 22 (the floor surface of the cargo area 160). Specifically, the floor surface of the cargo area 160 is positioned so that the seat backs 172 are flush with the floor surface of the cargo area 160 when the seat backs 172 are tilted forward (or backward).

The tail gate 166 is a gate provided in an opening 178 (FIG. 5A) at the rear end of the vehicle 22. In the first embodiment, the tail gate 166 opens and closes in the horizontal direction (see FIGS. 5A and 5B). In other words, hinges not shown are provided on the right or left at the back of the vehicle 22 so as to extend in the vertical direction. While the vehicle 22 is connected with the house 20, the tail gate 166 is a part of the side wall 82 of the house 20. The left door 168 and the right door 170 are so-called sliding doors. In the following description, the left door 168 and the right door 170 are also called “sliding doors 168, 170” or “doors 168, 170”.

### (A-1-3-3. Traveling System 152)

The traveling system 152 makes the vehicle 22 travel and includes a drive device 180, a braking device 182, and a steering device 184 as shown in FIG. 1. The drive device 180 generates a driving force for traveling the vehicle 22 and has a driving motor. The braking device 182 generates a braking force for the vehicle 22 and has a frictional brake device. In a case where the driving motor is regeneratively operated to decelerate the vehicle 22, the driving motor may be a portion of the braking device. The steering device 184 is a so-called electric power steering (EPS) device for controlling the steering of the vehicle 22 and has a steering, an EPS motor, and the like, for example.

### (A-1-3-4. Automated Parking Switch 154)

The automated parking switch 154 is a switch that commands automated connection control (discussed later) to an electronic control device 208 of the automated parking apparatus 156 and is provided in a cabin 190 (FIG. 3B, for instance) (for example, near a driver's seat).

### (A-1-3-5. Automated Parking Apparatus 156)

The automated parking apparatus 156 executes automated connection control to automatically connect the vehicle 22 to the house 20. The automated connection control includes automated parking control, which allows the vehicle 22 to be automatically parked in the garage 52. As shown in FIG. 1, the automated parking apparatus 156 includes traveling sensors 200, a communication device 202, a gate actuator 204, a door actuator 206, the electronic control device 208 (hereinafter called “ECU 208”), and a display device 210.

The traveling sensors 200 include multiple sensors utilized for running of the vehicle 22. The sensors herein include a speed sensor, an accelerator operation amount sensor, a brake operation amount sensor, and a steering angle sensor, for example. When the vehicle 22 effects cruise assistance or automated driving, the traveling sensors 200 would include a surround-view camera, a front radar, a global positioning system device (GPS device), and the like.

The communication device 202 performs input and output of signals between the vehicle 22 and the house 20 or the like. The gate actuator 204 automatically opens and closes the tail gate 166 and includes an electric motor, for example. The door actuator 206 is for automatically opening and closing the left door 168 and the right door 170 and includes electric motors corresponding to the left door 168 and the right door 170, respectively, for example.

The ECU 208 includes an input/output unit 220, a computation unit 222, and a storage unit 224 as hardware components. The input/output unit 220 performs input and output between the ECU 208 and external devices (for example, the parking assist apparatus 32).

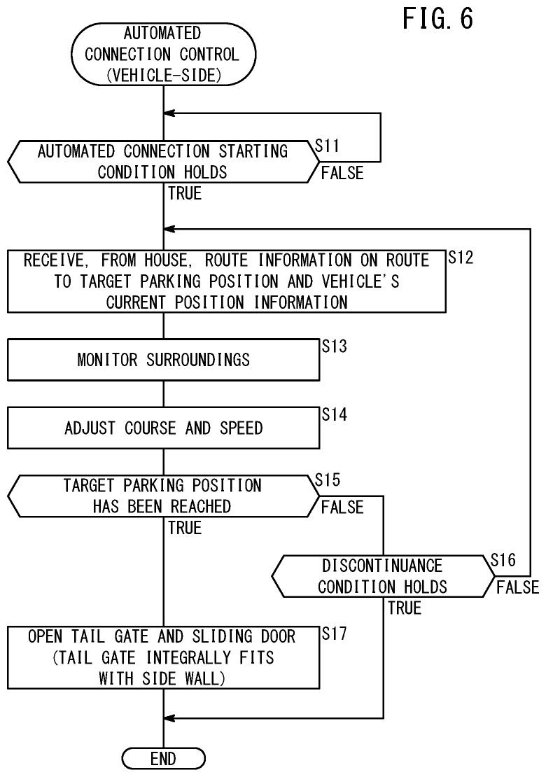

The computation unit 222 includes a central processing unit (CPU) and controls the traveling system 152 using programs and data stored in the storage unit 224. The computation unit 222 executes automated parking control, which allows the vehicle 22 to be automatically parked in the parking space 62 (described in more detail below with reference to FIG. 6).

The storage unit 224 stores programs and data for use by the computation unit 222 and includes RAM. The storage unit 224 may also have ROM in addition to the RAM. The display device 210 shows various screens during automated parking and the like.

### A-2. Control in the First Embodiment

### [A-2-1. Overview of Control]

In the first embodiment, the automated parking apparatus 156 of the vehicle 22 executes automated connection control (an automated driving mode), which makes the vehicle 22 automatically move from near the house 20 to the target parking position Ptar in the house 20 and connects the vehicle 22 with the house 20. “Connection” as used herein means joint of the floor surface of the vehicle 22 and the floor 80 of the house 20 or bringing them into close to the joined condition. When the automated parking switch 154 is pressed and automated connection control is started, the vehicle 22 recognizes a surrounding environment and moves autonomously regardless of the driving mode before the connection. The parking assist apparatus 32 of the house 20 executes connection assist control, which assists in the automated connection control by the vehicle 22.

Before specifically describing these controls, a specific flow of automatically connecting the vehicle 22 to the house 20 is described.

FIG. 2 is a perspective view showing a first situation during connection of the vehicle 22 to the house 20 in the first embodiment. FIGS. 3A, 4A, and 5A are plan views showing second to fourth situations during connection of the vehicle 22 to the house 20 in the first embodiment. FIGS. 3B, 4B, and 5B are side views corresponding to FIGS. 3A, 4A, and 5A.

When the vehicle 22 approaches the house 20 and performs automated connection, the shutter 60 of the house 20 opens (see arrow A in FIG. 2). At this point, the vehicle 22 waits in front of the shutter 60 until the shutter 60 has opened. After the shutter 60 opened, the vehicle 22 moves into the house 20 (FIGS. 3A to 5B). Specifically, the vehicle 22 proceeds toward the target parking position Ptar in the parking space 62 while obtaining information from the parking assist apparatus 32 of the house 20.

When the vehicle 22 has reached the target parking position Ptar, the tail gate 166 and the left door 168 of the vehicle 22 automatically open (FIGS. 5A and 5B). The open tail gate 166 integrally fits with the side wall 82 of the house 20 (FIGS. 5A and 5B). The open left door 168 is positioned between the body of the vehicle 22 and the lattice 70. As can be seen from FIGS. 5A and 5B, while the vehicle 22 is connected with the house 20, the cargo area 160 (the floor surface) of the vehicle 22 and the floor 80 of the house 20 are flush with each other (although they are not required to be flush).

### [A-2-2. Automated Connection Control on Vehicle 22]

FIG. 6 is a flowchart of automated connection control in the first embodiment. At step S11, the ECU 208 determines whether an automated connection starting condition holds or not. The automated connection starting condition may be that the automated parking switch 154 has been pressed, for example. The automated connection starting condition may be some other condition as well. Other condition can be that the house 20 has been set as a target location for a navigation device not shown and the distance to the house 20 or the target parking position Ptar has become below a predetermined distance, for example. When the automated connection starting condition holds (S11: TRUE), the flow proceeds to step S12; when the automated connection starting condition does not hold (S11: FALSE), step S11 is repeated.

At step S12, the ECU 208 receives, from the house 20, route information Ir on a route to the target parking position Ptar and current position information Ipc of the vehicle 22. The route information Ir and the current position information Ipc are received from the parking assist apparatus 32 via the communication device 202. Before starting to receive the route information Ir and current position information Ipc, the ECU 208 may send a request signal to request the start of transmission of the route information Ir and the current position information Ipc to the control device 108 of the house 20.

The route information Ir is information on travel paths around and within the house 20. The current position information Ipc is information on the current position Pc of the vehicle 22 itself. While the current position Pc may be obtained from a navigation device (or a global positioning system (GPS) device) not shown, it is possible that the current position Pc cannot be detected by the GPS device when the vehicle 22 is inside the house 20. Thus, the ECU 208 may instead determine the current position Pc based on a received signal from the beacon 100.

At step S13, the ECU 208 monitors the surroundings of the vehicle 22 using information from the traveling sensors 200. Specifically, the ECU 208 determines whether an obstacle such as a human or a bicycle is present in the surroundings of the vehicle 22 or not. In monitoring of the surroundings, the ECU 208 may obtain and utilize information of the garage sensors 102 from the control device 108 of the house 20.

At step S14, the ECU 208 adjusts the course and speed of the vehicle 22 based on the route information Ir, the current position information Ipc, and a result of surrounding monitoring. For example, when there are no particular obstacles around the vehicle 22, the ECU 208 makes the vehicle 22 move toward the target parking position Ptar at a predetermined speed (for example, any value from 1 to 10 km/h). When a human is present in the surroundings of the vehicle 22, the ECU 208 makes the vehicle 22 stop and wait until the human has moved away from the vehicle 22 by a predetermined distance or more.

At step S15, the ECU 208 determines whether the vehicle 22 has reached the target parking position Ptar or not. When the vehicle 22 has not reached the target parking position Ptar (S15: FALSE), then at step S16 the ECU 208 determines whether a discontinuance condition holds or not. The discontinuance condition can be that a brake pedal not shown has been pressed by a predetermined amount or more, for example. When the discontinuance condition holds (S16: TRUE), the authority to drive the vehicle 22 is handed over to the driver and the automated connection control is terminated. When the discontinuance condition does not hold (S16: FALSE), the flow returns to step S12.

When the vehicle 22 has reached the target parking position Ptar at step S15 (S15: TRUE), then at step S17 the ECU 208 activates the gate actuator 204 to open the tail gate 166, making the tail gate 166 integrally fit with the side wall 82 (see FIGS. 5A and 5B). The ECU 208 also activates the door actuator 206 to open the left door 168 and positions it between the body of the vehicle 22 and the lattice 70 (see FIG. 5A).

Which ones of the tail gate 166, the left door 168, and the right door 170 are to be opened and which ones are not is previously set in the storage unit 124 or 224 in accordance with the house 20 (or its floor plan). Alternatively, one(s) of the tail gate 166, the left door 168, and the right door 170 that should be opened may be determined based on information detected by the traveling sensors 200 (for example, image information).

In FIG. 5A, the distance between the left door 168 and the lattice 70 (in the vertical direction in FIG. 5A) is set with a target value which is a value that prevents a person from passing between them (for example, any value from 1 to 30 cm), for example. The target value is also previously set in the storage unit 124 or 224 in accordance with the house 20 (or its floor plan).

### [A-2-3. Connection Assist Control in House 20]

FIG. 7 is a flowchart of connection assist control in the first embodiment. At step S21, the control device 108 of the house 20 determines whether a connection assist starting condition holds or not. The connection assist starting condition can be that a request signal from the ECU 208 has been received, for example. When the connection assist starting condition holds (S21: TRUE), the flow proceeds to step S22; when the connection assist starting condition does not hold (S21: FALSE), step S21 is repeated (or a monitoring state is maintained).

At step S22, the control device 108 activates the shutter actuator 106 to open the shutter 60. At step S23, the control device 108 detects the current position Pc of the vehicle 22 based on detected values from the garage sensors 102.

At step S24, the control device 108 sends, to the vehicle 22, route information Ir on a route from the current position Pc of the vehicle 22 to the target parking position Ptar (target connection position) and the current position information Ipc of the vehicle 22. If opening of the shutter 60 is not complete, the route indicated by the route information Ir may end before the shutter 60. The route information Ir and the current position information Ipc are sent from the parking assist apparatus 32 to the ECU 208 via the communication device 104.

At step S25, the control device 108 determines whether the vehicle 22 has reached the target parking position Ptar or not. When the vehicle 22 has not reached the target parking position Ptar (S25: FALSE), then at step S26 the control device 108 determines whether a discontinuance condition holds or not. The discontinuance condition can be that a discontinuance signal has been received from the ECU 208, for example. When the discontinuance condition holds (S26: TRUE), the control device 108 ends the current connection assist control. When the discontinuance condition does not hold (S26: FALSE), the flow returns to step S23.

When the vehicle 22 has reached the target parking position Ptar at step S25 (S25: TRUE), then at step S27 the control device 108 activates the shutter actuator 106 to close the shutter 60. A trigger for the timing of closing the shutter 60 may be that the vehicle 22 has moved away from the shutter 60 by a predetermined distance. Alternatively, the shutter actuator 106 may be activated to close the shutter 60 based on a user's instruction. Alternatively, the shutter 60 could be manually closed.

### A-3. Effects of the First Embodiment

As described above, in the first embodiment, the tail gate 166 (the first opening and closing element) in an open state is made to integrally fit with the side wall 82 (wall) while the cargo area 160 (floor surface) of the vehicle 22 (mobile entity) is connected with the floor 80 of the house 20 (building) (FIGS. 5A and 5B). This can simplify a displacement mechanism for the tail gate 166 compared to a case of positioning the rear door (the first opening and closing element) on a side of an automobile (mobile entity) as in JP 2001-271500 A, so that the operability can be improved or costs can be reduced. In a case where the vehicle 22 is a vehicle with the sliding doors 168, 170 (in other words, at least one of the left door 168 and the right door 170 is a sliding door), getting on and off is also possible through the sliding doors 168, 170 when getting on and off between the vehicle 22 and the house 20 takes place, which improves convenience.

In the first embodiment, the house 20 (building) has, in the side wall 82 (wall) of the house 20, the housing portion 90 (FIG. 3A) for housing at least a portion of the tail gate 166 (the first opening and closing element) when the tail gate 166 is placed in an open state during connection with the vehicle 22 (mobile entity) (FIG. 5A, for instance). This enables the tail gate 166 to be placed at a specific position when getting on and off between the vehicle 22 and the house 20 takes place, which can improve the operability.

In the first embodiment, the tail gate 166 (the first opening and closing element) opens and closes in the horizontal direction (FIGS. 5A and 5B). This enables getting on and off between the vehicle 22 and the house 20 to be done by opening the tail gate 166 in the horizontal direction even if the height of the ceiling 84 of the house 20 has significant limitations.

In the first embodiment, the vehicle 22 (mobile entity) has the seats 162, 164 on which occupants can sit (FIG. 1). The seat backs 172 of the seats 162, 164 are capable of being housed under the floor so as to be flush with the floor surface of the vehicle 22. This allows effective use of the floor surface of the vehicle 22 (the surface of the cargo area 160) while the vehicle 22 is connected with the house 20.

In the first embodiment, the house 20 (building) has, at a location adjacent to the entrance 50, the parking space 62 in which the vehicle 22 (mobile entity) is parked during connection (FIGS. 2 and 3A, for instance). This can make the point of entry and exit to/from the house 20 through the entrance 50 and the point of entry and exit to/from the house 20 through the vehicle 22 close to each other. Thus, the layout of the house 20 can be simplified compared to when the two points are apart from each other.

In the first embodiment, when the sliding door 168 (the second opening and closing element) provided on a side of the vehicle 22 (mobile entity) is placed in an open state by being moved from an initial position to another position with the vehicle 22 stopped in a stopping space, an opening 169 formed in the initial position communicates with the entrance 50 (FIGS. 5A and 5B). Thus, opening of the sliding door 168 permits an occupant getting off the vehicle 22 to immediately get to the entrance.

In the first embodiment, the house 20 (building) has the lattice 70 which is situated between the entrance 50 and the sliding door 168 (the second opening and closing element) when the sliding door 168 is placed in an open state with the vehicle 22 (mobile entity) stopped in the stopping space (FIG. 5A). This allows the sliding door 168 in an open state to be housed between the lattice 70 and the vehicle 22.

In the first embodiment, the vehicle 22 (mobile entity) performs connection in automated connection control (an automated driving mode) in which the vehicle 22 recognizes a surrounding environment and moves autonomously regardless of the driving mode before the connection (FIG. 6). This permits easy connection of the vehicle 22 to the house 20.

In the first embodiment, recognition of the surrounding environment by the vehicle 22 (mobile entity) includes communication performed between the vehicle 22 and the house 20 (building) (FIGS. 6 and 7). This can improve the accuracy of positioning of the vehicle 22 relative to the house 20.

### B. Second Embodiment

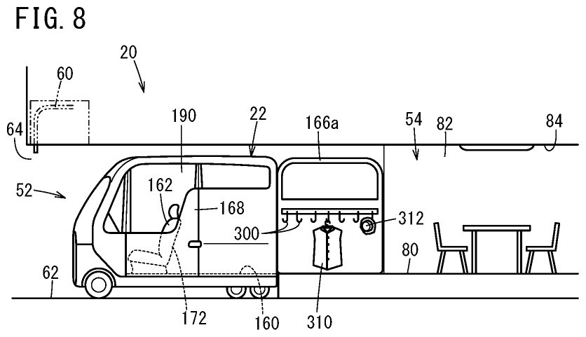

FIG. 8 is a side view showing a situation of connection between the house 20 and the vehicle 22 included in the connection system 10 according to a second embodiment. Of the components included in the second embodiment, ones that are similar to ones in the first embodiment are given the same reference numerals and are not described in detail again. In FIG. 8, the sliding doors 168, 170 are in a closed state.

In the second embodiment, multiple hooks 300 for hanging a garment 310, a hat 312, and the like are provided on a tail gate 166a. This allows the hooks 300 to be used at least when the tail gate 166a is opened. The hooks 300 may also be used while the tail gate 166a is closed.

### C. Third Embodiment

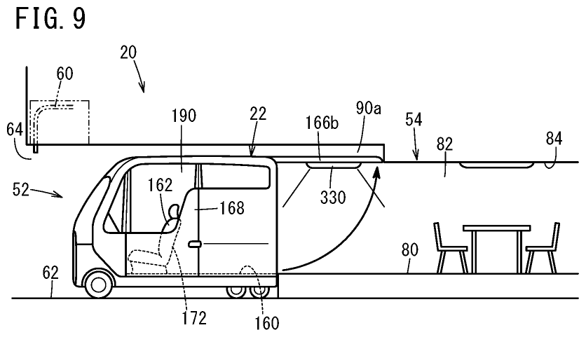

FIG. 9 is a side view showing situation of connection between the house 20 and the vehicle 22 included in the connection system 10 according to a third embodiment. Of the components included in the third embodiment, ones that are similar to ones in the first embodiment are given the same reference numerals and are not described in detail again. In FIG. 9, the sliding doors 168, 170 are in a closed state.

The tail gates 166, 166a of the first and second embodiments open and close in the horizontal direction (FIGS. 5A, 5B, and 8, for instance). By contrast, a tail gate 166b in the third embodiment opens and closes in the vertical direction (FIG. 9). When the tail gate 166b is open, the tail gate 166b is housed in a housing portion 90a of the ceiling 84. This allows getting on and off between the vehicle 22 (mobile entity) and the house 20 (building) to be done by opening the tail gate 166b in the vertical direction even if the position of the side wall 82 of the house 20 has significant limitations.

In the third embodiment, a lighting device 330 is provided on the tail gate 166b. The lighting device 330 operates with electric power from an in-vehicle battery (not shown). On/off control of the lighting device 330 is made from a switch (not shown) provided on the lighting device 330. Alternatively, the lighting device 330 may be switchable between three steps, “On”, “Off”, and “Door”, as with common room lamps such that when “Door” is selected, the lighting device 330 is turned on upon opening of the tail gate 166b and turned off after elapse of a certain amount of time.

Provision of the lighting device 330 as described above allows the lighting device 330 to be used at least when the tail gate 166b is opened. The lighting device 330 may also be used while the tail gate 166b is closed.

### D. Variations

It will be apparent that the present invention is not limited to the foregoing embodiments but can employ different configurations based on the descriptions herein. For example, the following configurations can be employed.

### D-1. House 20

In the first embodiment, the building to which the vehicle 22 connects is the house 20 (FIG. 1, for instance). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, the vehicle 22 may connect to other kinds of building. The same applies to the second and third embodiments.

In the first embodiment, the parking space 62 is provided inside the house 20 (FIG. 2, for instance). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, the parking space 62 may be provided outside the house 20.

In the first embodiment, the housing portion 90 (FIG. 3A) houses the tail gate 166 in its entirety (FIG. 5A, for instance). However, the present invention is not limited thereto from the viewpoint of making the tail gate 166 a part of the side wall 82, for example. For instance, the side wall 82 could also house only a portion of the tail gate 166. The same applies to the second and third embodiments.

In the first embodiment, the housing portion 90 for housing the tail gate 166 is formed in the side wall 82 (FIG. 5A, for instance). However, the present invention is not limited thereto from the viewpoint of making the tail gate 166 a part of the side wall 82, for example. For instance, the tail gate 166 could have a tapered tip so that the tail gate 166 can be a part of the side wall 82 without provision of the housing portion 90. The same applies to the second and third embodiments.

In the first embodiment, the entrance 50 neighbors the parking space 62 (FIG. 2, for instance). However, the present invention is not limited thereto from the viewpoint of making the tail gate 166 (the first opening and closing element) of the vehicle 22 (mobile entity) integrally fit with the side wall 82 (wall) of the house 20 (building), for example; the parking space 62 may be provided at a location apart from the entrance 50. The same applies to the second and third embodiments.

In the first embodiment, the lattice 70 is provided between the entrance 50 and the parking space 62 (FIG. 2, for instance). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, a wall surface could be provided in place of the lattice 70. Alternatively, it is possible not to provide a partition, such as the lattice 70, between the entrance 50 and the garage 52. In other words, the entrance 50 and the garage 52 may be in direct communication. This can give the entrance 50 a sense of openness. The same applies to the second and third embodiments.

### D-2. Vehicle 22

The vehicle 22 in the first embodiment is a battery-powered automobile (FIG. 1). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, the vehicle 22 may be a hybrid vehicle with an engine and a driving motor as power sources. The same applies to the second and third embodiments.

In the first embodiment, the mobile entity which connects to the house 20 or building is the vehicle 22 (FIG. 1, for instance). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, if the house 20 or building faces a water surface such as a lake, the mobile entity which connects to the house 20 or building may be a ship. The same applies to the second and third embodiments. Alternatively, the present invention may be applied to a mobile entity other than a vehicle.

The tail gate 166 in the first embodiment is assumed to be substantially rectangular parallelepiped (FIGS. 5A and 5B). However, the present invention is not limited thereto from the viewpoint of making a portion of the tail gate 166 a part of the side wall 82 or the ceiling 84, for example. For instance, the tail gate 166 may be curved partially or entirely. In that case, a portion of the tail gate 166 may make contact with the side wall 82 or the ceiling 84 at an angle.

The second embodiment provides the hooks 300 on the tail gate 166a (FIG. 8), and the third embodiment provides the lighting device 330 on the tail gate 166b (FIG. 9). However, other kinds of accessories could be provided on the tail gate 166, 166a, 166b. For example, a shoes box could be provided on the tail gate 166a if the tail gate 166a opens in the horizontal direction.

In the first embodiment, the tail gate 166 integrally fits with a wall (the side wall 82) of the house 20 (FIGS. 5A and 5B). However, the present invention is not limited thereto from the viewpoint of making the opening and closing element of the vehicle 22 (or a mobile entity) integrally fit with a wall (the side wall 82) of the house 20, for example. For instance, either the doors 168, 170 on the sides of the vehicle 22 could integrally fit with a wall of the house 20.

In the first embodiment, the side wall 82 (wall) for housing the tail gate 166 is situated on the opposite side of the entrance 50 (FIG. 3A). However, the present invention is not limited thereto from the viewpoint of making the opening and closing element of the vehicle 22 (or a mobile entity) integrally fit with a wall (the side wall 82) of the house 20, for example. For instance, the wall (the side wall 82) for housing the tail gate 166 could be located on the side of the entrance 50 (in other words, in place of the lattice 70).

In the first embodiment, the tail gate 166 integrally fits with a wall (the side wall 82) of the house 20 (FIGS. 5A and 5B). However, the present invention is not limited thereto from the viewpoint of making the opening and closing element of the vehicle 22 (or a mobile entity) integrally fit with a portion of the house 20, for example. For instance, the tail gate 166 may integrally fit with the lattice 70. In other words, the lattice 70 may be situated between the entrance 50 and the tail gate 166 (the first opening and closing element) when the tail gate 166 (the first opening and closing element) provided on a side of the vehicle 22 is placed in an open state with the vehicle 22 stopped in the parking space 62. This enables the tail gate 166 in an open state to be housed between the lattice 70 and the vehicle 22.

In the first embodiment, the seat backs 172 of the left seat 162 and the right seat 164 can be housed under the floor so as to be flush with the floor surface of the vehicle 22. However, the present invention is not limited thereto from the viewpoint of making the tail gate 166 (the first opening and closing element) of the vehicle 22 (mobile entity) integrally fit with the side wall 82 (wall) of the house 20 (building), for example; a configuration that does not make the seat backs 172 flush with the floor surface of the vehicle 22 is also possible. The same applies to the second and third embodiments.

In the first embodiment, the automated parking apparatus 156 performs automated connection control using information from the parking assist apparatus 32 of the house 20 (FIG. 6). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, automated connection control could be performed only with information that is acquired by the automated parking apparatus 156 on its own. The same applies to the second and third embodiments.

In the first embodiment, the vehicle 22 is capable of automated parking control (FIG. 6). However, the present invention is not limited thereto from the viewpoint of making the tail gate 166 (the first opening and closing element) of the vehicle 22 (mobile entity) integrally fit with the side wall 82 (wall) of the house 20 (building), for example. For instance, the automated parking apparatus 156 may not be included. The same applies to the second and third embodiments.

### D-3. Automated Connection Control and Connection Assist Control

In the automated connection control of the first embodiment, after the vehicle 22 has reached the target parking position Ptar (S15 in FIG. 6: TRUE), the tail gate 166 is automatically opened to integrally fit with the side wall 82 (S17). However, the present invention is not limited thereto from the viewpoint of making the tail gate 166 of the vehicle 22 integrally fit with a wall of the house 20 (such as the side wall 82), for example; the tail gate 166 may be manually opened to integrally fit with the wall. The same applies to the second and third embodiments.

In the first embodiment, automated connection control and connection assist control are performed on the assumption that the tail gate 166 and the side wall 82 can integrally fit with each other (see FIGS. 6 and 7). However, the present invention is not limited thereto from the viewpoint of making an integral fitting after determining whether opening of the tail gate 166 (or integral fitting between the tail gate 166 and the side wall 82) is possible, for example. For instance, the vehicle 22 may communicate with the house 20 or a server not shown, and the tail gate 166 may be automatically opened only after confirming that the integral fitting between the tail gate 166 and the side wall 82 is possible. In a case where the vehicle 22 is to park in a house 20 that does not allow the integral fitting between the tail gate 166 and the side wall 82, control to make the vehicle 22 automatically travel to the target parking position Ptar could be performed without automated opening of the tail gate 166. In other words, automated connection control that does not perform the step S17 of FIG. 6 can be performed. The same applies to the second and third embodiments.

In the automated connection control of the first embodiment (FIG. 6), both of the tail gate 166 and the sliding door 168 are opened (S17). However, only either one of them could be opened. Alternatively, the right door 170 may be opened in addition to the tail gate 166 and the left door 168.

### E. Reference Signs List

10 connection system
20 house (building)
22 vehicle (mobile entity)
50 entrance
62 parking space (stopping space)
70 lattice
80 floor
82 side wall (wall)
84 ceiling (wall)
90, 90a housing portion
160 cargo area (floor surface)
162 left seat
164 right seat
166, 166a, 166b tail gate (first opening and closing element)
168, 170 sliding door (second opening and closing element)
172 seat back
178 opening in the rear of a vehicle
190 cabin
300 hooks
330 lighting device

1. A connection system comprising:
a mobile entity; and
a building having a floor which connects to a floor surface of the mobile entity, and a wall which integrally fits with a first opening and closing element of the mobile entity in an open state while the floor surface of the mobile entity is connected with the floor,
wherein the mobile entity performs connection in an automated driving mode in which the mobile entity recognizes a surrounding environment and moves autonomously regardless of a driving mode before the connection.

2. The connection system according to claim 1, wherein the building has, in the wall of the building, a housing portion for housing at least a portion of the first opening and closing element when the first opening and closing element is placed in an open state during connection with the mobile entity.

3. The connection system according to claim 2, wherein
the first opening and closing element is a gate provided in an opening at an end of the mobile entity, and
the gate opens and closes in a horizontal direction.

4. The connection system according to claim 2, wherein
the first opening and closing element is a gate provided in an opening of the mobile entity, and
the gate opens in a vertical direction.

5. The connection system according to claim 3, wherein the gate has hooks or a lighting device on an interior-side surface of the gate.

6. The connection system according to claim 1, wherein the mobile entity has seats on which occupants can sit, and
seat backs of the seats are capable of being housed under a floor so as to be flush with a floor surface of the mobile entity.

7. The connection system according to claim 1, wherein the building has, at a location adjacent to an entrance, a stopping space in which the mobile entity is stopped during connection.

8. The connection system according to claim 7, wherein when a second opening and closing element provided on a side of the mobile entity is placed in an open state by being moved from an initial position to another position with the mobile entity stopped in the stopping space, an opening formed in the initial position communicates with the entrance.

9. The connection system according to claim 8, wherein the building has a wall surface or a lattice which is situated between the entrance and the second opening and closing element when the second opening and closing element is placed in an open state with the mobile entity stopped in the stopping space.

10. (canceled)

11. The connection system according to claim 1, wherein recognition of the surrounding environment includes communication performed between the mobile entity and the building.

12-13. (canceled)
